(19) United States
(12) Patent Application Publication
(10) Pub. No.: US 2019/0034987 A1
(43) Pub. Date: Jan. 31, 2019

(54) INFORMATION PROCESSING APPARATUS

(71) Applicant: FUJI XEROX CO., LTD., Tokyo (JP)

(72) Inventor: Masanori Yoshizuka, Kanagawa (JP)

(73) Assignee: FUJI XEROX CO., LTD., TOKYO (JP)

(21) Appl. No.: 15/951,181

(22) Filed: Apr. 12, 2018

(30) Foreign Application Priority Data
Jul. 28, 2017 (JP) 2017-146515

(51) Int. Cl. G06Q 30/02; G06F 17/50

(52) U.S. Cl. CPC G06Q 30/0283; G06F 2217/41; G06F 17/50

(57) ABSTRACT

An information processing apparatus includes a decision unit and a calculation unit. The decision unit decides the range of a slide using a CAVI/CORE under surface extracted from drawing information on a mold. The calculation unit calculates the price of the slide from the range of the slide.

### CROSS-REFERENCE TO RELATED APPLICATIONS

This application is based on and claims priority under 35 USC 119 from Japanese Patent Application No. 2017-146515 filed Jul. 28, 2017.

### BACKGROUND

### Technical Field

The present invention relates to an information processing apparatus.

### SUMMARY

According to an aspect of the present invention, there is provided an information processing apparatus including: a decision unit that decides a range of a slide using a CAVI/CORE under surface extracted from drawing information on a mold; and a calculation unit that calculates a price of the slide from the range of the slide.

### BRIEF DESCRIPTION OF THE DRAWINGS

An exemplary embodiment of the present invention will be described in detail based on the following figures, wherein:

FIG. 1 is a conceptual module configuration diagram illustrating a configuration example according to an exemplary embodiment;

FIG. 2 illustrates a system configuration example that utilizes the exemplary embodiment;

FIG. 3 is a flowchart illustrating a process example according to the exemplary embodiment;

FIG. 4 illustrates a process example according to the exemplary embodiment;

FIG. 5 is a flowchart illustrating a process example according to the exemplary embodiment;

FIG. 6 illustrates a process example according to the exemplary embodiment;

FIGS. 7A and 7B illustrate a process example according to the exemplary embodiment;

FIGS. 8A to 8D illustrate a process example according to the exemplary embodiment;

FIGS. 9A and 9B illustrate a process example according to the exemplary embodiment;

FIGS. 10A to 10C illustrate a process example according to the exemplary embodiment;

FIG. 11 illustrates a data structure example of a slide block table;

FIG. 12 is a flowchart illustrating a process example according to the exemplary embodiment;

FIGS. 13A and 13B illustrate a process example according to the exemplary embodiment;

FIG. 14 illustrates a data structure example of a slide cost table; and

FIG. 15 is a block diagram illustrating a hardware configuration example of a computer that implements the exemplary embodiment.

### DETAILED DESCRIPTION

A preferable exemplary embodiment for implementing the present invention will be described below with reference to the drawings.

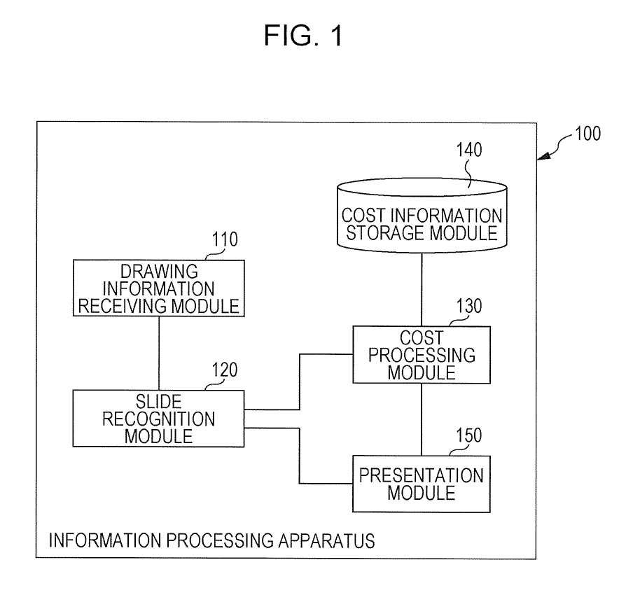

FIG. 1 is a conceptual module configuration diagram illustrating a configuration example according to an exemplary embodiment.

The term “module” generally refers to parts such as software (computer program) and hardware that are logically separable from each other. Thus, the modules in the exemplary embodiment include not only modules based on computer programs but also modules based on hardware components. Therefore, the exemplary embodiment also describes a computer program for causing a computer to function as such modules (a program for causing a computer to execute such procedures, a program for causing a computer to function as such units, and a program for causing a computer to implement such functions), a system, and a method. It should be noted, however, that language “store” and “cause . . . to store” and equivalent language is used for convenience of description. In the case where the exemplary embodiment describes a computer program, however, such language means to “cause a storage device to store” or “perform control so as to cause a storage device to store”. In addition, the modules may make one-to-one correspondence with the functions. In implementation, however, one module may be constituted of one program, plural modules may be constituted of one program, or conversely one module may be constituted of plural programs. In addition, plural modules may be executed by one computer, or one module may be executed by plural distributed or parallel computers. One module may include another module. In the following description, in addition, the term “connection” is used to indicate not only physical connections but also logical connections (for data exchange, instruction, data reference, etc.). The term “predetermined” means that the modificand has been determined before the target process, and may be used to mean that the modificand is determined in accordance with the situation or the state at the time, or the situation or the state in the past, before the target process even after the process according to the exemplary embodiment is started, not to mention before the process according to the exemplary embodiment is started. In the case where there are plural “predetermined values”, such values may be different from each other, or two or more (or all, as a matter of course) of such values may be the same as each other. In addition, the wording “in the case where A, then B” is used to mean “it is determined whether or not A, and in the case where it is determined that A, then B”. It should be noted, however, that cases where it is not necessary to determine whether or not A are excluded. In the case where elements are listed as in “A, B, and C”, such listing is exemplary unless stated otherwise, and includes a case where only one of the elements (e.g. A alone) is selected.

In addition, the system or the device may be constituted of plural computers, hardware, devices, etc. connected by a communication unit such as a network (including a one-to-one communication connection), or may be implemented by one computer, hardware, device, etc. The terms “device” and “system” are used as synonyms for each other. As a matter of course, the term “system” does not include mere social “schemes” (social systems) which are artificial arrangements.

In addition, after each process performed by each module, or after each of plural processes performed in a module, target information is read from a storage device, and the result of the process is written into the storage device after the process is performed. Thus, reading from the storage device before the process and writing into the storage device after the process may not be described. Examples of the storage device may include a hard disk, a random access memory (RAM), an external storage medium, a storage device via a communication line, and a register in a central processing unit (CPU).

An information processing apparatus 100 according to the present exemplary embodiment calculates the price of a slide from drawing information on a mold, and includes, as illustrated in the example of FIG. 1, a drawing information receiving module 110, a slide recognition module 120, a cost processing module 130, a cost information storage module 140, and a presentation module 150.

A mold (die) is used to manufacture a plastic part, for example. The mold is often expensive, and therefore a quotation for the cost of the mold is prepared.

The mold occasionally includes a slide. The “slide” (which is occasionally referred to also as a “slide core”) refers to a portion inside the mold that slides as the mold is opened and closed. That is, the term refers to a portion at which a part (molded article) is moved in the transverse direction (or oblique direction) with respect to the opening direction of the mold. In other words, the term refers to a portion at which the part is moved in a direction that is different from the CAVI/CORE direction. An undercut process is performed in conjunction with open/close operation of the mold in order to mold an undercut portion of the part. If the undercut is larger, it is necessary to make an angular pin longer, the amount of movement of the slide core is also larger, and thus the price of the mold is also higher.

Thus, the information processing apparatus 100 decides the range of the slide, and calculates the price of the slide portion.

The drawing information receiving module 110 is connected to the slide recognition module 120. The drawing information receiving module 110 receives drawing information on a mold for computer-aided design (CAD) or the like. The term “drawing information” refers to information that indicates the three-dimensional shape of a mold. To receive drawing information includes receiving drawing information generated by an operation (design work) by a user such as a designer, reading drawing information stored in a hard disk (built in a computer, connected via a network, or the like), and so forth. The drawing information to be received may be information about one drawing, or may be information about plural drawings.

The slide recognition module 120 is connected to the drawing information receiving module 110, the cost processing module 130, and the presentation module 150. The slide recognition module 120 decides (which has a concept including “recognizes”) the range of a slide using a CAVI/CORE under surface extracted from the drawing information on a mold which is received by the drawing information receiving module 110. The phrase “CAVI/CORE under surface” refers to a surface that may not be drafted in the CAVI or CORE direction. The CAVI/CORE under surface may be extracted using the technique described in Japanese Patent No. 4623134 or the like.

The slide recognition module 120 may decide the range of the slide using a first point for a case where there is an obstruction on a line drawn in the CAVI direction or the CORE direction from a point on the periphery of the CAVI/CORE under surface as a starting point. The phrase “periphery of the surface” is referred to also as an “edge (outline)”.

The slide recognition module 120 may decide the height, width, and depth of the slide from the range in which the first point is present. The phrase of “depth of a slide” is referred to also as an under amount (amount of movement of a slide). The height, width, and depth of the slide are decided on the basis of the “range in which the first point is present”, not simply on the basis of only the periphery of the surface. A portion at which there is no obstruction on a line drawn in the CAVI direction or the CORE direction (a line may be drafted in the CAVI direction or the CORE direction) is not included in the range of the slide. Consequently, a portion not formed as a slide is not included in the range of the slide.

The slide recognition module 120 may integrate plural slides on the basis of the decided range of the plural slides.

In this case, the cost processing module 130 may calculate the price of the slides integrated by the slide recognition module 120.

The slide recognition module 120 may integrate the slides, the draft direction of which is the same.

The slide recognition module 120 may integrate the slides in the case where the price of the integrated slides is less than or equal to the price of the slides which are not integrated.

In this case, the cost processing module 130 may calculate the price of the slides integrated by the slide recognition module 120.

The cost processing module 130 is connected to the slide recognition module 120, the cost information storage module 140, and the presentation module 150. The cost processing module 130 calculates the price of the slide from the range of the slide which is decided by the slide recognition module 120. In this event, the cost processing module 130 may use a price calculation formula that has the height, width, and depth of the slide as parameters, or may use a table (information stored in the cost information storage module 140) that stores a price that matches the size of the slide.

The cost information storage module 140 is connected to the cost processing module 130. The cost information storage module 140 stores information for calculating the price of the slide. For example, the cost information storage module 140 stores a slide cost table 1400. FIG. 14 illustrates a data structure example of the slide cost table 1400. The slide cost table 1400 includes a slide block size field 1410 and a cost field 1420. The slide block size field 1410 stores the size (e.g. the height, width, depth, etc. of a slide) of a slide block. The cost field 1420 stores the price (cost) of the slide block.

The presentation module 150 is connected to the slide recognition module 120 and the cost processing module 130. The presentation module 150 presents the price which is calculated by the cost processing module 130 or the slide which is decided by the slide recognition module 120. The “presenting” may include “displaying on a display device such as a liquid crystal display” and “outputting as a three-dimensional image”, which may be combined with “printing using a printing device such as a printer”, “outputting a sound using a sound output device such as a speaker”, “vibration”, etc. For example, when displaying a mold, a slide portion may be displayed in a color that is different from colors for other portions.

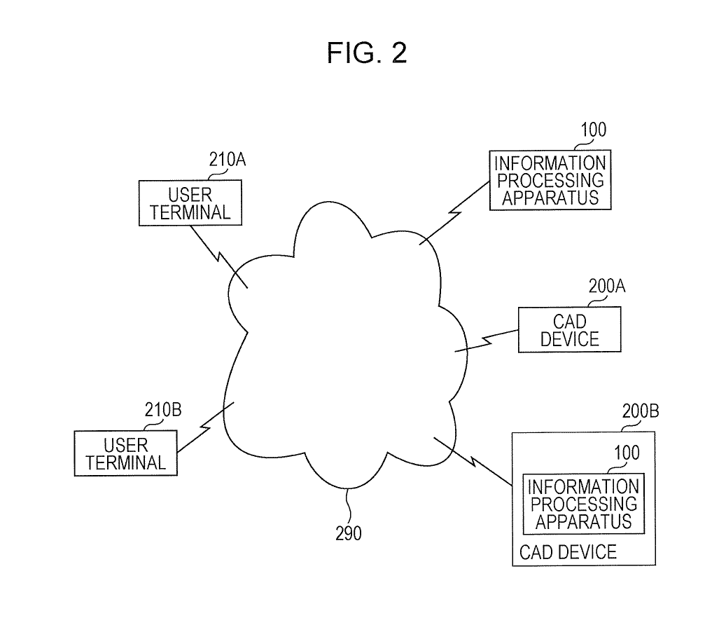

FIG. 2 illustrates a system configuration example that utilizes the exemplary embodiment.

A CAD device 200B includes the information processing apparatus 100. The information processing apparatus 100, a CAD device 200A, the CAD device 200B, a user terminal 210A, and a user terminal 210B are connected to each other via a communication line 290. The communication line 290 may be wireless, wired, or a combination of both, and may be the Internet, an intranet, etc. that serves as a communication infrastructure, for example. The functions of the information processing apparatus 100 and the CAD device 200 may be implemented as cloud services.

For example, the user as the designer prepares a design drawing of a mold utilizing the CAD device 200 via the user terminal 210A. Drawing information as the design drawing is stored in the CAD device 200. A manager of a design group makes a quotation for the designed mold utilizing the information processing apparatus 100 via the user terminal 210B. The information processing apparatus 100 takes out the drawing information in the CAD device 200, decides the range of a slide, makes a quotation for a mold, and presents a price (which may include a price for each portion such as a slide) as the quotation result to the manager.

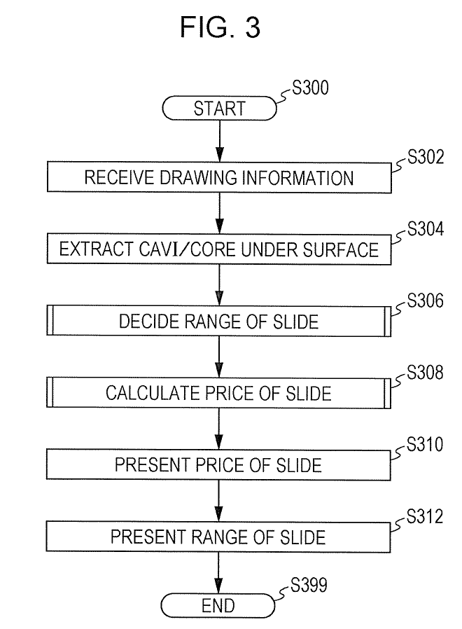

FIG. 3 is a flowchart illustrating a process example according to the exemplary embodiment.

In step S302, the drawing information receiving module 110 receives drawing information on a mold.

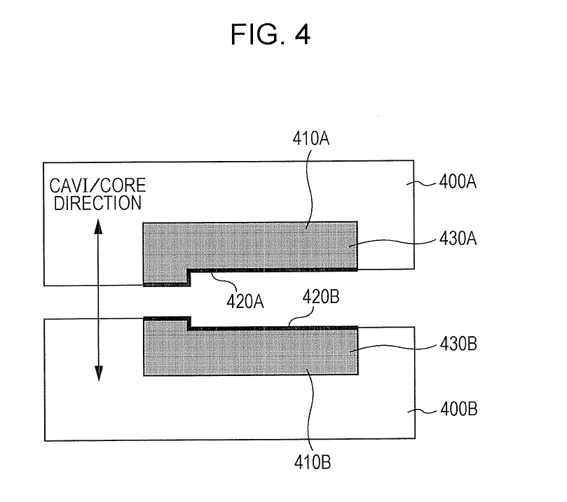

In step S304, the slide recognition module 120 extracts a CAVI/CORE under surface. Step S304 will be described with reference to the example of FIG. 4. FIG. 4 illustrates a process example according to the exemplary embodiment. A mold 400A and a mold 400B are each a CAVI or CORE mold. In general, the mold 400A is a CAVI mold, and the mold 400B is a CORE mold.

A CAVI/CORE surface 430A and a CAVI/CORE surface 430B are each a surface prepared by the mold 400A or the mold 400B just moving in the CAVI direction or the CORE direction (the vertical direction in FIG. 4).

However, a CAVI/CORE under surface 420A and a CAVI/CORE under surface 420B are each a surface (CAVI/CORE under surface) not prepared by the mold 400A or the mold 400B just moving in the CAVI direction or the CORE direction.

The CAVI/CORE under surface 420A and the CAVI/CORE under surface 420B may be extracted using an existing technique (e.g. the technique described in Japanese Patent No. 4623134).

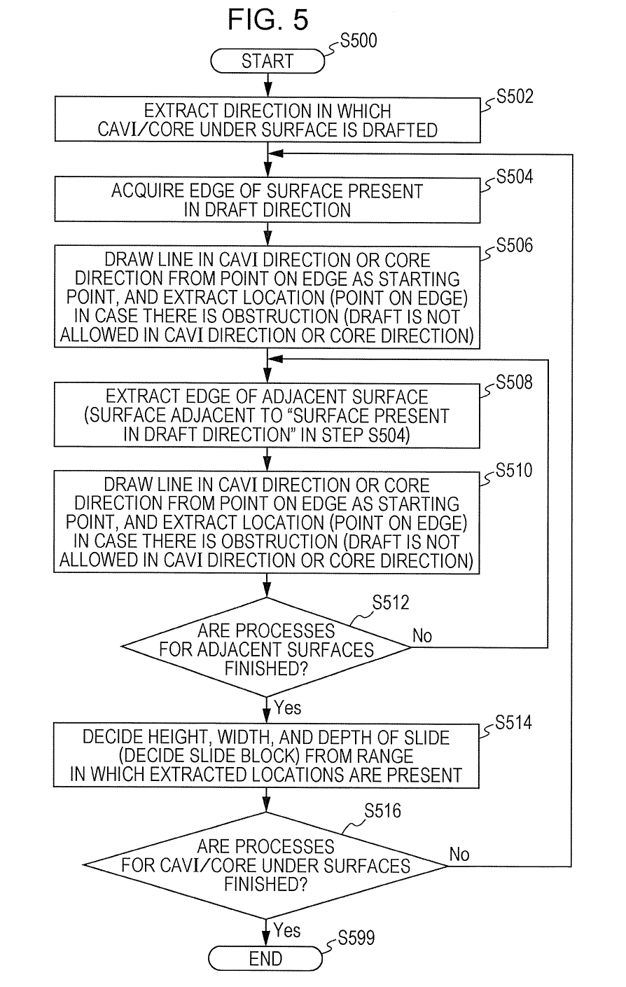

In step S306, the slide recognition module 120 decides the range of the slide. The process in step S306 will be discussed in detail later using the flowchart illustrated in the example of FIG. 5.

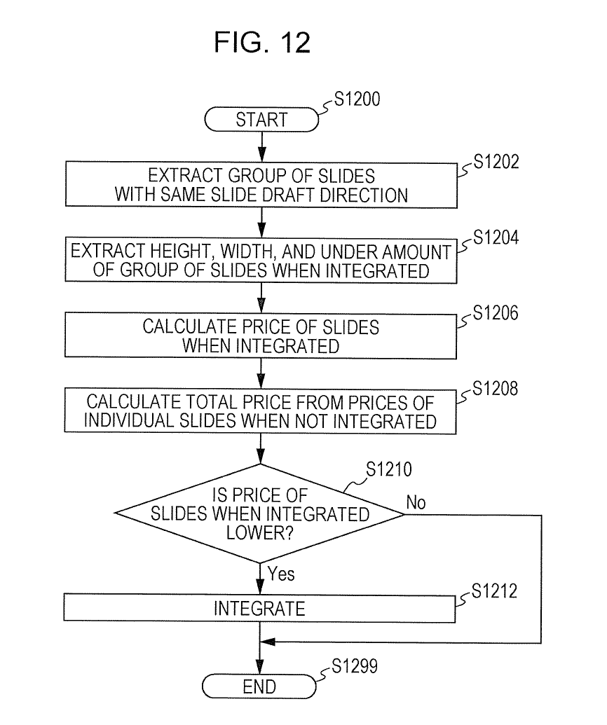

In step S308, the cost processing module 130 calculates the price of the slide. The process in step S308 will be discussed in detail later using the flowchart illustrated in the example of FIG. 12.

In step S310, the presentation module 150 presents the price of the slide. As a matter of course, the price of the entire mold may be presented, and the price of the slide portion may be presented in an itemized form.

In step S312, the presentation module 150 presents the range of the slide. For example, when displaying a mold on a display, the range of the slide may be displayed in a color or the like that is different from those for others.

FIG. 5 is a flowchart illustrating a process example according to the exemplary embodiment. The drawing illustrates a detailed example of the process in step S306 of the flowchart illustrated in the example of FIG. 3.

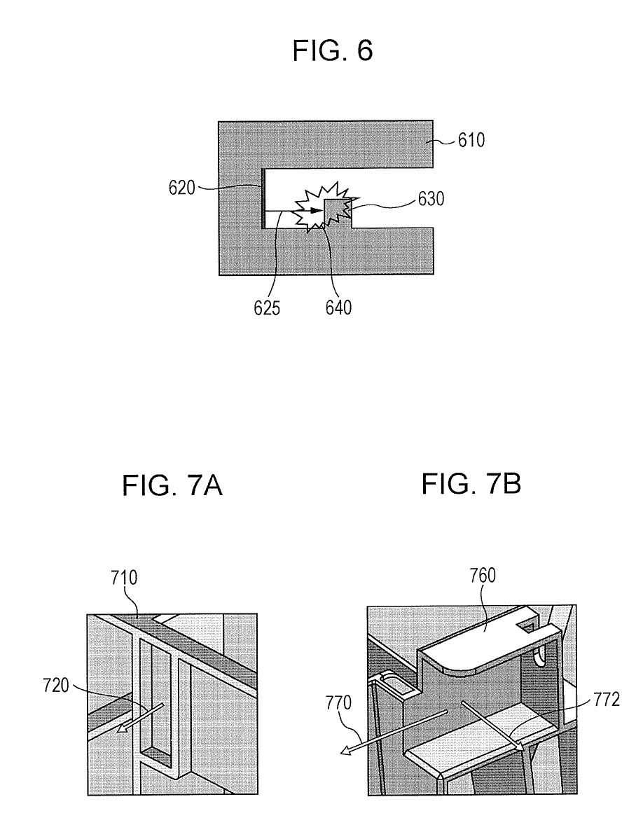

In step S502, a direction in which the CAVI/CORE under surface is drafted is extracted. Step S502 will be described with reference to FIGS. 6, 7A, and 7B. This process is performed for all the CAVI/CORE under surfaces.

FIG. 6 illustrates a process example according to the exemplary embodiment. A part 610 includes a projecting portion 630. In this case, a line 625 is drawn (referred to also as “a beam is emitted”) in a direction that is perpendicular to a CAVI/CORE under surface 620 (or a draft direction toward the outside) from a point on the surface (CAVI/CORE under surface 620). In this case, such a direction is not a draft direction in the case where a collision occurs 640. Conversely, such a direction is a draft direction if a collision does not occur.

FIGS. 7A and 7B illustrate a process example according to the exemplary embodiment. In the example of FIGS. 7A and 7B, surfaces (gray surfaces in FIGS. 7A and 7B) other than white surfaces are each a CAVI/CORE under surface.

In the example of FIG. 7A, a draft direction 720 is the only draft direction for a CAVI/CORE under surface (a surface at which the draft direction 720 starts) in a part 710.

In the example of FIG. 7B, two draft directions, namely a draft direction 770 and a draft direction 772, are provided for a CAVI/CORE under surface (a surface at which the draft direction 770 and the draft direction 772 start) in a part 760.

In step S504, an edge of a surface that is present in the draft direction is acquired.

In step S506, a line is drawn in the CAVI direction or the CORE direction from a point on the edge as the starting point. In the case where there is an obstruction (draft is not allowed in the CAVI direction or the CORE direction), the location (the point on the edge) is extracted.

In step S508, an edge of an adjacent surface (a surface that is adjacent to the “surface that is present in the draft direction” in step S504) is extracted.

In step S510, a line is drawn in the CAVI direction or the CORE direction from a point on the edge as the starting point. In the case where there is an obstruction (draft is not allowed in the CAVI direction or the CORE direction), the location (the point on the edge) is extracted.

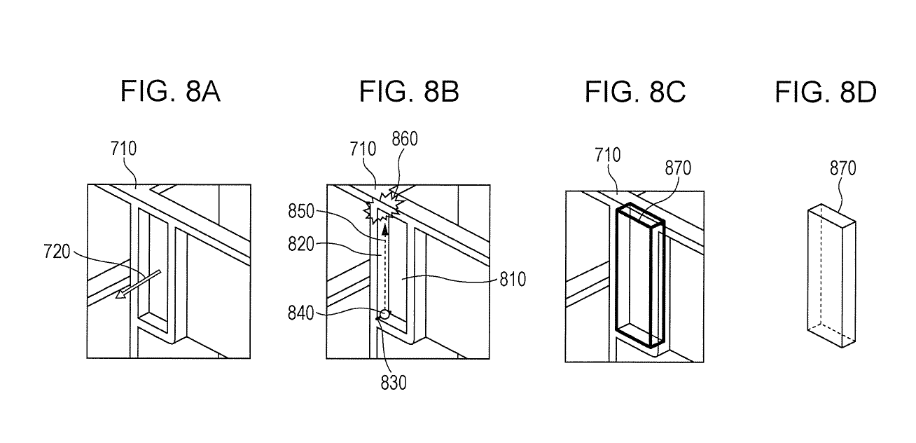

FIGS. 8A to 8D illustrate a process example according to the exemplary embodiment. The example of FIG. 8A is similar to the example of FIG. 7A. A process for the part 710 will be described.

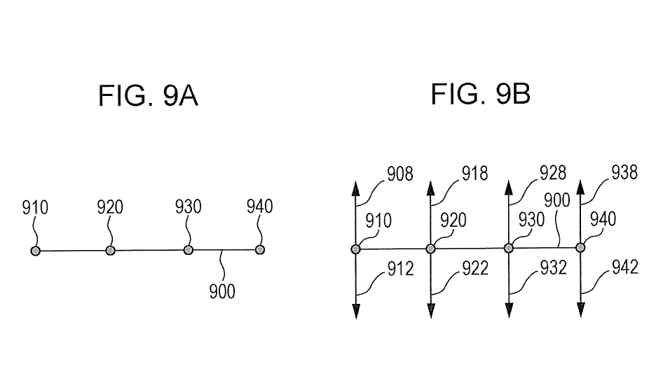

An edge 830 illustrated in the example of FIG. 8B has been extracted in step S508. That is, a collision occurs 860 in the case where edges (four sides) of a start surface 810 as the surface that is present in the draft direction are extracted in step S504, the process in step S506 is performed for the edges, and thereafter a line 850 is drawn in the CAVI direction from a point 840 on the edge 830 (the lower side in FIG. 8B) of a surface 820 that is adjacent to the start surface 810 as the starting point. The point 840 on the edge 830 is set as in FIG. 9A, for example. That starting points (point 910, point 920, point 930, point 940) are set on an edge 900 at predetermined intervals. Intervals between starting points in the vicinity of end points may be shorter than intervals between starting points in the vicinity of the center. This is because there are often portions that may be drafted without an obstruction in the vicinity of the end points. A line 908, a line 912, a line 918, a line 922, a line 928, a line 932, a line 938, and a line 942 are drawn in the CAVI direction and the CORE direction from each of the starting points (point 910, point 920, point 930, point 940). In the case where there is an obstruction, the starting point is extracted.

In step S512, it is determined whether or not processes for the adjacent surfaces are finished. In the case where such processes are finished, the process proceeds to step S514. Otherwise, the process returns to step S508.

In step S514, the height, width, and depth of the slide (a slide block is decided) from the range in which the locations which are extracted in step S506 and step S510 are present.

In the example of FIGS. 8A to 8D, a slide 870 illustrated in the example of FIG. 8C is extracted. That is, the slide 870 which is a rectangular parallelepiped such as that illustrated in the example of FIG. 8D is extracted.

In step S516, it is determined whether or not processes for all the CAVI/CORE under surfaces are finished. In the case where such processes are finished, the process is ended (step S599). Otherwise, the process returns to step S504.

A slide that may be drafted in only one direction (A) may be processed preferentially. In such a case, in the case where a slide that may be drafted in two or more directions may be drafted in the same direction as the one direction (A), the slide may be processed for only such a direction.

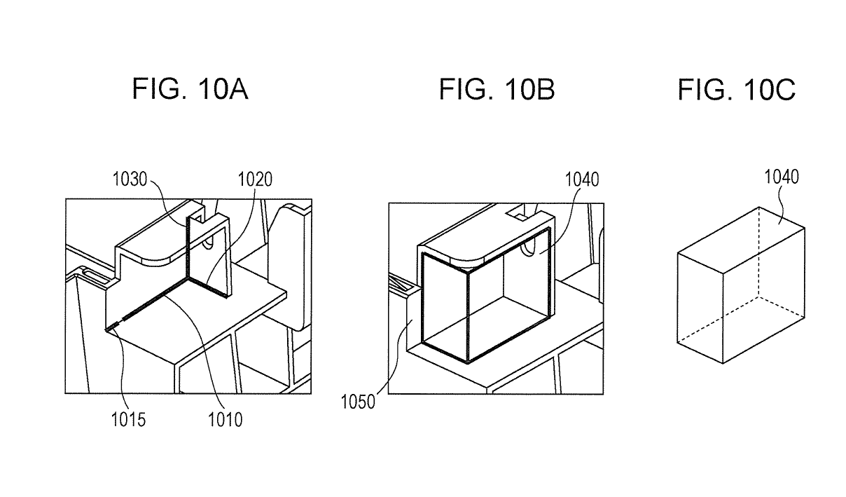

FIGS. 10A to 10C illustrate a process example according to the exemplary embodiment. While there is no point that may be drafted in the example of FIGS. 8A to 8D, the following describes a case where there is a point that may be drafted.

A location with an obstruction 1010, a location with an obstruction 1020, and a location with an obstruction 1030 correspond to the width, depth, (under amount), and height, respectively, of the slide range.

Regardless of the presence of a portion of a CAVI/CORE under surface 1050 as illustrated in the example of FIG. 10B, a location without an obstruction 1015 may be drafted in the CAVI direction or the CORE direction at the edge, and thus is not included in the range of a slide 1040. That is, this is because an adjacent surface (a surface having the location with an obstruction 1020, the location with an obstruction 1010, and the location without an obstruction 1015 (also including the location without an obstruction 1015 which is an extended portion of the location with an obstruction 1010) as edges) is larger than a facing surface. Specifically, a portion without an obstruction on a line drawn in the CAVI direction or the CORE direction from the location without an obstruction 1015 is the location without an obstruction 1015. The location without an obstruction 1015 is not included in the slide 1040. The slide 1040 is constituted by the location with an obstruction 1010 (which does not include a portion of the location without an obstruction 1015), the location with an obstruction 1020, and the location with an obstruction 1030. In the example of FIGS. 10A to 10C, the slide 1040 illustrated in the example of FIG. 10B is extracted. That is, the slide 1040 which is a rectangular parallelepiped such as that illustrated in the example of FIG. 10C is extracted.

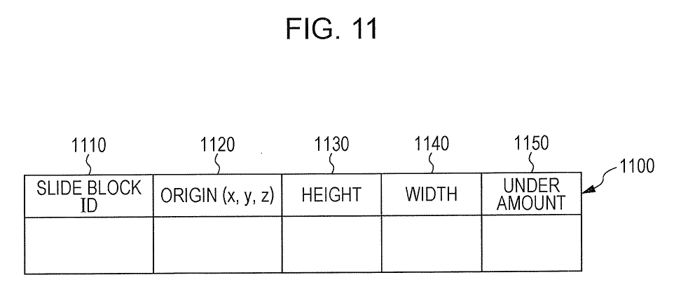

A slide block table 1100 is generated as a result of the process in step S514. FIG. 11 illustrates a data structure example of the slide block table 1100. The slide block table 1100 includes a slide block identification (ID) field 1110, an origin (x, y, z) field 1120, a height field 1130, a width field 1140, and an under amount field 1150. The slide block ID field 1110 stores information (slide block ID) for uniquely identifying a slide block in the exemplary embodiment. The origin (x, y, z) field 1120 stores the coordinates (x, y, z) of the origin of the slide block. The height field 1130 stores the height of the slide block. The width field 1140 stores the width of the slide block. The under amount field 1150 stores the under amount (depth) of the slide block. A rectangular parallelepiped slide block is taken as an example. However, the slide block may be a pentagonal column, a circular column, or the like. In such cases, parameters that indicate the form of the slide block may be stored in a slide block table with a data structure with such parameters.

In the case where there are two draft directions, a slide block with the smaller under amount may be extracted. This is because a slide block with a smaller under amount results in a lower price.

FIG. 12 is a flowchart illustrating a process example according to the exemplary embodiment. The drawing illustrates a detailed example of the process in step S308 of the flowchart illustrated in the example of FIG. 3. The process also includes a slide integration process. This is because integrated slide blocks often result in a lower price.

In step S1202, a group of slides with the same slide draft direction is extracted.

In step S1204, the height, width, and under amount of the group of slides extracted in step S1202 and when integrated are extracted. The slides may be integrated since the slides have the same draft direction.

In step S1206, the price of the slides when integrated is calculated. As discussed earlier, the price of the slides when integrated may be calculated utilizing the slide cost table 1400.

In step S1208, the total price is calculated from the prices of the individual slides when not integrated. As discussed earlier, the prices of the individual slides may be calculated utilizing the slide cost table 1400.

In step S1210, it is determined whether or not the price of the slides when integrated is the lower. If the price of the slides when integrated is the lower, the process proceeds to step S1212. Otherwise, the process is ended (step S1299).

In step S1212, the relevant group of slides is integrated.

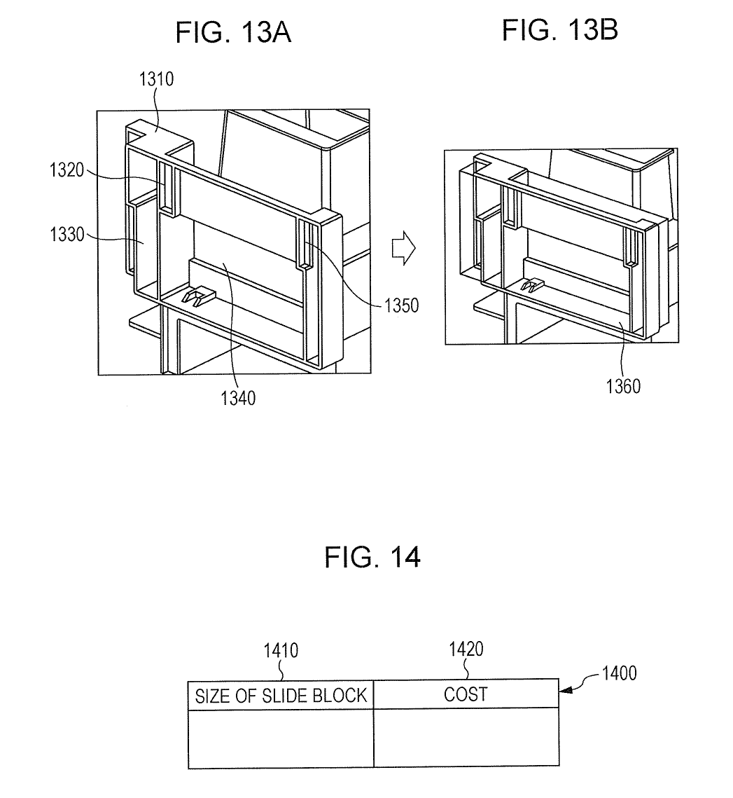

FIG. 13 illustrates a process example according to the exemplary embodiment.

In the example illustrated in FIG. 13, four slide blocks (a slide block 1320, a slide block 1330, a slide block 1340, and a slide block 1350) are extracted from a part 1310. The slide block 1320, all of the slide block 1330, the slide block 1340, and the slide block 1350 are drafted in the same direction, and thus integrated to generate an integrated slide block 1360. The price of the integrated slide block 1360 and a price obtained by adding the respective prices of the slide block 1320, the slide block 1330, the slide block 1340, and the slide block 1350 are compared to present the lower price.

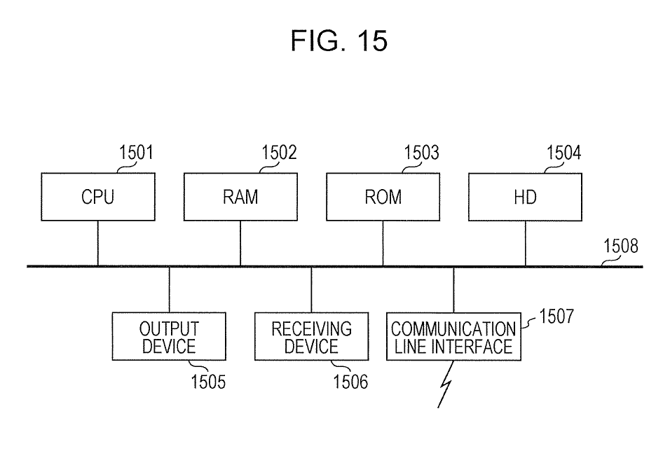

As illustrated in FIG. 15, the hardware configuration of a computer that executes a program as the exemplary embodiment is a common computer, specifically a computer that may serve as a personal computer, a server, or the like. That is, as a specific example, the computer includes a CPU 1501 as a processing section (computation section) and a RAM 1502, a read only memory (ROM) 1503, and a hard disk (HD) 1504 as storage devices. The HD 1504 may be a hard disk drive or a solid state drive (SSD), for example. The computer is composed of: the CPU 1501 which executes programs such as the drawing information receiving module 110, the slide recognition module 120, the cost processing module 130, and the presentation module 150; the RAM 1502 which stores the programs and data; the ROM 1503 which stores a program for starting the computer etc.; the HD 1504 which is an auxiliary storage device (which may be a flash memory or the like) that has the function as the cost information storage module 140; a receiving device 1506 that receives data on the basis of an operation (including motion, a voice, a line of sight, etc.) performed by the user on a keyboard, a mouse, a touch screen, a microphone, a camera (including a line-of-sight detection camera etc.), or the like; an output device 1505 such as a cathode ray tube (CRT), a liquid crystal display, a speaker, etc.; a communication line interface 1507 for connection with a communication network such as a network interface card; and a bus 1508 that connects such parts for data exchange. Plural computers may be connected to each other through a network.

The exemplary embodiment discussed earlier implemented by a computer program is implemented by causing a system of the hardware configuration described above to read the computer program as software and causing the software and hardware resources to cooperate with each other.

The hardware configuration illustrated in FIG. 15 indicates one configuration example. The exemplary embodiment is not limited to the configuration illustrated in FIG. 15, and may have any configuration that may execute the modules described in relation to the exemplary embodiment. For example, some of the modules may be constituted by dedicated hardware (such as an application specific integrated circuit (ASIC), for example), some of the modules may be provided in an external system and connected through a communication line, and further plural systems illustrated in FIG. 15 may be connected to each other through a communication line to cooperate with each other. In addition, and in particular, the system may be incorporated into not only a personal computer but also a portable information communication device (including a cellular phone, a smartphone, a mobile device, a wearable computer, etc.), an information appliance, a robot, a copier, a facsimile, a scanner, a printer, a multi-function device (image processing device that has the functions of two or more of a scanner, a printer, a copier, a facsimile, etc.), etc.

The program described above may be provided as stored in a storage medium, or the program may be provided by a communication unit. In this case, the program described above may be considered as an invention of a “computer-readable storage medium that stores a program”, for example.

The term “computer-readable storage medium that stores a program” refers to a computer-readable storage medium that stores a program and that is used to install, execute, and distribute the program.

Examples of the storage medium include digital versatile discs (DVDs) that conform to standards prescribed by the DVD Forum “DVD-R, DVD-RW, DVD-RAM, etc.”, DVDs that conform to standards prescribed by the DVD+RW Alliance “DVD+R, DVD+RW, etc.”, compact discs (CDs) such as read-only memory (CD-ROM), CD recordable (CD-R), and CD rewritable (CD-RW), Blu-ray (registered trademark) discs, magneto-optical (MO) disks, flexible disks (FDs), magnetic tapes, hard disks, read-only memories (ROMs), electrically erasable reprogrammable read-only memories (EEPROMs (registered trademark)), flash memories, random-access memories (RAMS), and SD (Secure Digital) memory cards.

A part or all of the program described above may be saved, distributed, etc. as stored in the storage medium. In addition, a part or all of the program may be transferred through communication using a transfer medium such as a wired network, a wireless communication network, or a combination thereof used as a local area network (LAN), a metropolitan area network (MAN), a wide area network (WAN), the Internet, an intranet, an extranet, or the like, or may be carried over a carrier wave.

Further, the program described above may be a part or all of another program, or may be stored in a storage medium together with another program. Alternatively, the program may be stored as divided in plural storage media. In addition, the program may be compressed, encrypted, or stored in any form as long as the program may be restored.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a decision unit that decides a range of a slide using a CAVI/CORE under surface extracted from drawing information on a mold; and
a calculation unit that calculates a price of the slide from the range of the slide.

2. The information processing apparatus according to claim 1,
wherein the decision unit decides the range of the slide using a first point for a case where there is an obstruction on a line drawn in a CAVI direction or a CORE direction from a point on a periphery of the CAVI/CORE under surface as a starting point.

3. The information processing apparatus according to claim 2,
wherein a height, a width, and a depth of the slide are decided from a range in which the first point is present.

4. The information processing apparatus according to claim 1, further comprising
an integration unit that integrates a plurality of slides on a basis of a range of the slides decided by the decision unit,
wherein the calculation unit calculates a price of the integrated slides.

5. The information processing apparatus according to claim 4,
wherein the integration unit integrates the slides draft directions of which are the same.

6. The information processing apparatus according to claim 4,
wherein the integration unit integrates the slides in a case where a price of the integrated slides is less than or equal to a price of the slides which are not integrated.

7. The information processing apparatus according to claim 6,
wherein the calculation unit calculates a price of the slides integrated by the integration unit.
